(19) United States
(12) Patent Application Publication
(10) Pub. No.: US 2026/0088665 A1
(43) Pub. Date: Mar. 26, 2026

(54) WAVE WINDING RING TERMINAL HIGH VOLTAGE CONNECTION

(71) Applicant: Schaeffler Technologies AG & Co. KG, Herzogenaurach (DE)

(72) Inventor: Zachary Gnabah, Massillon, OH (US)

(73) Assignee: Schaeffler Technologies AG & Co. KG, Herzogenaurach (DE)

(21) Appl. No.: 18/897,423

(22) Filed: Sep. 26, 2024

(51) Int. Cl. H02K 1/16; H02K 3/12; H02K 5/22

(52) U.S. Cl. CPC H02K 1/16; H02K 3/12; H02K 5/22

(57) ABSTRACT

An electric motor includes a stator having a stator carrier and stator windings supported by the stator carrier, and at least one terminal coupled to the stator windings, the at least one terminal is crimped to first and second conductors of the stator winding.

### TECHNICAL FIELD

The present disclosure relates generally to an electric motor for a hybrid or electric vehicle, and more specifically to a high-voltage connection of the electric motor.

### BACKGROUND

Electrical machines comprising a rotor and a stator are used in different areas of application. The use of electric machines for electric hybrid vehicles and electric vehicles or for hub drives is only mentioned as an example. If such an electrical machine is used as a drive machine, it is mostly designed as an internal rotor, which means that the stator surrounds the internal rotor. A moving magnetic field is generated via the stator, which causes the rotor to rotate. For this purpose, the stator has a winding consisting of a multiplicity of conductors, the conductors being assigned to one or usually several phases.

Not only the number of phases goes into the design of the winding geometry, but also the number of wires per phase as well as the number of wires per slot within the stator toothing and the number of pole pairs. This variety of conductors and winding parameters creates a complex network of conductors that is built up using different winding technologies. Examples include what is known as hairpin or bar wave winding. Here, the conductors are formed by means of rods bent in a U-shape, which are put together to form a winding cage. The conductors are laid on a plurality of radial levels, with the conductors moving from level to level. To form quasi-meandering, circumferential conductors, they are to be connected accordingly at their ends, which is usually done by welding the conductor ends which are adjacent to one another. The conductor ends converge at one point or on one winding side in the form of a so-called star, where they are connected to one another. In this area, the connection of the individual phases to an external power supply, often also called a high-voltage terminal, which power supply is used to generate the magnetic field, must be made, which is often very difficult to implement for reasons of installation space.

A busbar or connection ring is typically used to connect the windings. Such connection rings may be installed axially adjacent the windings and coupled thereto to provide, in the case of a three-phase motor, three connection points. The connection points can be crimped or otherwise connected to respective high-voltage phase conductors.

### SUMMARY

In accordance with one aspect of the present disclosure, a stator of an electric motor comprises a stator carrier, stator windings supported by the stator carrier, and at least one terminal coupled to the stator windings. The at least one terminal is crimped to first and second conductors of the stator winding.

The first and second conductors can extend over an axial end of the stator windings. The terminal can extend radially inwardly from the stator windings. The terminal can include a ring terminal having an aperture for receiving a fastener for coupling the ring terminal to an electric power source. The aperture can be aligned to receive a fastener in an axial direction of the stator. The stator windings can include a plurality of conductors comprising first, second and third windings. The at least one terminal coupled to the stator windings can include a terminal coupled to each of the first, second and third windings. Each of the terminals can be crimped to a respective pair of conductors of the windings. The terminals can be ring terminals having an aperture for receiving a fastener for coupling to an electric power source. The aperture can be aligned to receive a fastener in an axial direction of the stator.

In accordance with another aspect of the present disclosure, an electric motor comprises a stator including a stator carrier and stator windings supported by the stator carrier, and at least one terminal coupled to the stator windings. The at least one terminal can be crimped to first and second conductors of the stator winding.

The first and second conductors can extend over an axial end of the stator windings. The terminal can extend radially inwardly from the stator windings. The terminal can include a ring terminal having an aperture for receiving a fastener for coupling the ring terminal to an electric power source. The aperture can be aligned to receive a fastener in an axial direction of the stator. The stator windings can include a plurality of conductors comprising first, second and third windings. The at least one terminal coupled to the stator windings can include a terminal coupled to each of the first, second and third windings. Each of the terminals can be crimped to a respective pair of conductors of the windings. The terminals can be ring terminals having an aperture for receiving a fastener for coupling to an electric power source. The aperture can be aligned to receive a fastener in an axial direction of the stator.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of an exemplary stator in accordance with the present disclosure.

FIG. 2 is another perspective view of the stator.

FIG. 3 is an enlarged portion of FIG. 2.

FIG. 4 is an enlarged perspective view of the stator.

FIG. 5 is a perspective view of an exemplary electric motor including a stator in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

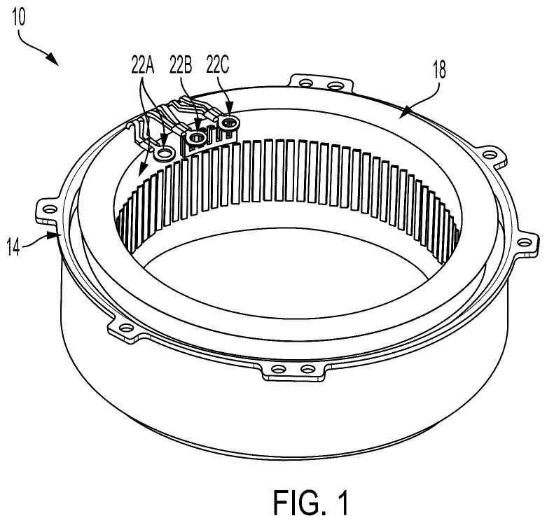

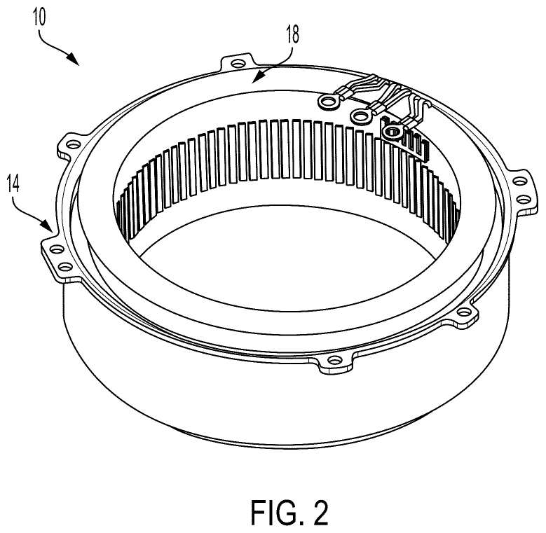

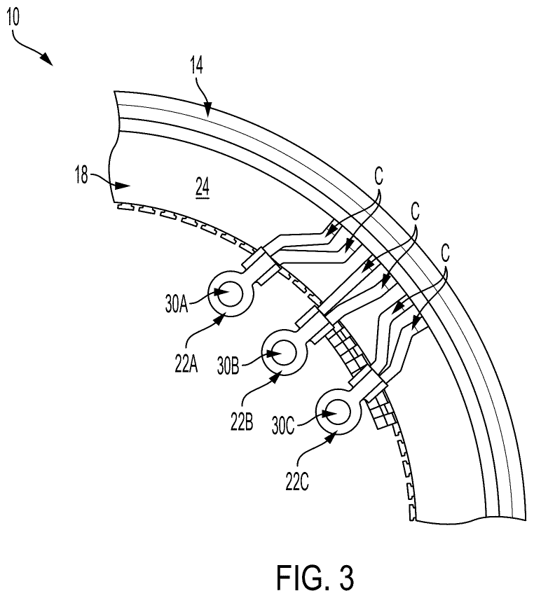

Referring to FIGS. 1-5, an exemplary stator of an electric motor in accordance with the present disclosure is illustrated and identified generally by reference numeral 10. The stator includes a stator carrier 14 supporting windings 18. The windings 18 are schematically illustrated in the drawings in simplified form (e.g., a block). As noted above, one type of winding that can be used is a wave wound (also referred to as a continuous wound) distributed wound stator winding. Other types of stator windings can be implemented without departing from the scope of the present disclosure.

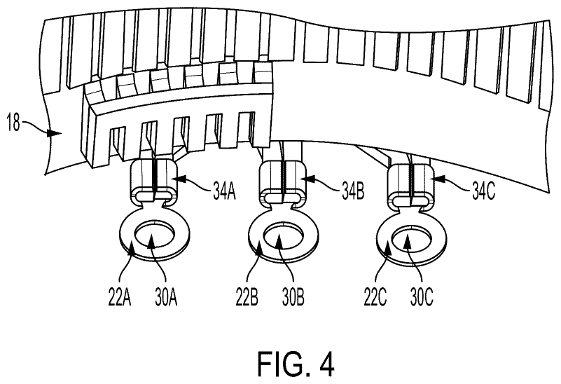

Contrary to existing stators implementing a connection ring wherein conductors of the respective main windings are coupled to the connection ring (also called a busbar), the stator 10 includes three phase connections in the form of ring terminals 22A, 22B and 22C. Each of the ring terminals 22A, 22B and 22C are directly crimped to first and second conductors C of the windings of the stator 10. In the illustrated embodiment, the conductors C are bent over the top (e.g., an axial end/welded end 24) of the windings 18 to minimize an axial dimension of the stator 10. Each of the ring terminals 22A, 22B and 22C protrude radially inwardly from the stator winding 18. Each of the ring terminals 22A, 22B and 22C include an aperture 30A, 30B, 30C configured to receive a fastener, such as a bolt, extending in an axial direction for coupling the ring terminals 22A, 22B and 22C to a high-voltage junction box or other source of electric power. Each ring terminal 22A, 22B and 22C includes a crimp section 34A, 34B and 34C adapted to be crimped around two respective conductors C, as best seen in FIG. 4, for example.

By crimping the ring terminals to the 22A, 22B and 22C to the conductors C of the windings 18 directly, construction of the stator 10 is simplified by not adding a busbar or additional components. The stator 10 is more axially compact than a stator utilizing a busbar. Additionally, crimping the ring terminals 22A, 22B and 22C directly to conductors C the windings 18 adds robust mechanical connection and reduces additional connection points and possible failure points.

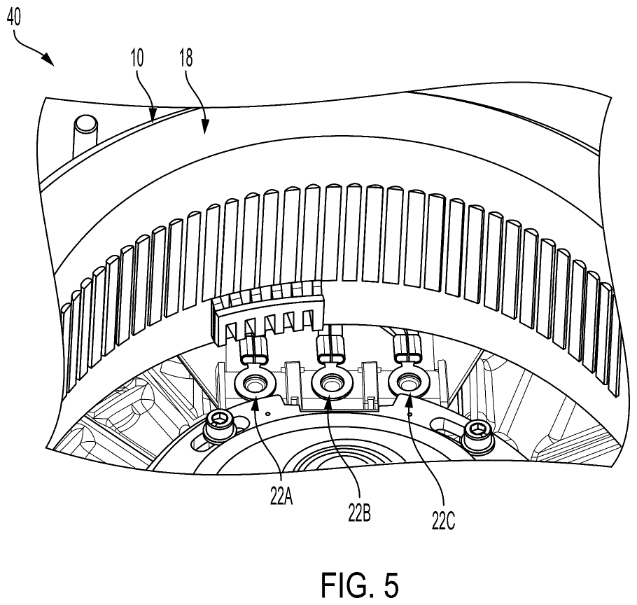

FIG. 5 illustrates the stator 10 as part of an electric motor 40 of a drive unit for a vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 stator
14 stator carrier
18 windings
22A ring terminal
22B ring terminal
22C ring terminal
24 axial end/welded ends of windings
30A aperture
30B aperture
30C aperture
34A crimp section
34B crimp section
34C crimp section

What is claimed is:

1. A stator of an electric motor comprising:
a stator carrier;
stator windings supported by the stator carrier; and
at least one terminal coupled to the stator windings;
wherein the at least one terminal is crimped to first and second conductors of the stator winding.

2. The stator according to claim 1, wherein the first and second conductors extend over an axial end of the stator windings.

3. The stator according to claim 2, wherein the terminal extends radially inwardly from the stator windings.

4. The stator according to claim 3, wherein the terminal includes a ring terminal having an aperture for receiving a fastener for coupling the ring terminal to an electric power source.

5. The stator according to claim 4, wherein the aperture is aligned to receive a fastener in an axial direction of the stator.

6. The stator according to claim 1, wherein the stator windings include a plurality of conductors comprising first, second and third windings.

7. The stator according to claim 6, wherein the at least one terminal coupled to the stator windings includes a terminal coupled to each of the first, second and third windings.

8. The stator according to claim 7, wherein each of the terminals are crimped to a respective pair of conductors of the windings.

9. The stator according to claim 8, wherein the terminals are ring terminals having an aperture for receiving a fastener for coupling to an electric power source.

10. The stator according to claim 9, wherein the aperture is aligned to receive a fastener in an axial direction of the stator.

11. An electric motor comprising:
a stator including a stator carrier and stator windings supported by the stator carrier; and
at least one terminal coupled to the stator windings;
wherein the at least one terminal is crimped to first and second conductors of the stator winding.

12. The electric motor according to claim 11, wherein the first and second conductors extend over an axial end of the stator windings.

13. The electric motor according to claim 12, wherein the terminal extends radially inwardly from the stator windings.

14. The electric motor according to claim 13, wherein the terminal includes a ring terminal having an aperture for receiving a fastener for coupling the ring terminal to an electric power source.

15. The electric motor according to claim 14, wherein the aperture is aligned to receive a fastener in an axial direction of the stator.

16. The electric motor according to claim 11, wherein the stator windings include a plurality of conductors comprising first, second and third windings.

17. The electric motor according to claim 16, wherein the at least one terminal coupled to the stator windings includes a terminal coupled to each of the first, second and third windings.

18. The electric motor according to claim 17, wherein each of the terminals are crimped to a respective pair of conductors of the windings.

19. The electric motor according to claim 18, wherein the terminals are ring terminals having an aperture for receiving a fastener for coupling to an electric power source.

20. The electric motor according to claim 19, wherein the aperture is aligned to receive a fastener in an axial direction of the stator.
